(19) United States
(12) Patent Application Publication
(10) Pub. No.: US 2013/0001365 A1
(43) Pub. Date: Jan. 3, 2013

(54) ORBITAL DEBRIS MITIGATION USING HIGH DENSITY PLASMA

(75) Inventor: Jin S. Kang, Philadelphia, PA (US)

(73) Assignee: DREXEL UNIVERSITY, Philadelphia, PA (US)

(21) Appl. No.: 13/174,883

(22) Filed: Jul. 1, 2011

(51) Int. Cl. B64G 1/10

(52) U.S. Cl. 244/158.6

(57) ABSTRACT

The present invention is directed to mitigating orbital debris in outer space by concentrating the plasma existing in space. The debris mitigation method involves sending a satellite device 1 into space that can concentrate local plasma in a surrounding region to create a relatively high density plasma field 5. The satellite device 1 comprises a plasma concentrator. By sending such a satellite device 1 into a desired obit where debris are to be mitigated, the debris passing through the created high density plasma field 5 is caused to encounter a drag force, which results in a faster orbital decay for the debris. Multiple devices may work in cooperation to influence the same orbital debris or to mitigate debris over a larger area.

### BACKGROUND OF THE INVENTION

1. Field of the Invention

The present invention is directed to methods and devices for mitigating orbital debris. In particular, the present invention is directed to using a satellite to concentrate plasma for decelerating orbital debris and causing its orbit to decay.

2. Description of the Related Technology

Orbital debris is a growing concern for the global community. After decades of spaceflight, there are estimated to be tens of millions of pieces of man-made debris in orbit around the Earth. This debris, ranging in size from sand-like particles to full-size inactive satellites, can severely damage or completely devastate any vehicle they may happen to impact. This presents a significant threat to the world's space infrastructure, i.e. communication satellites, the global positioning system (GPS) satellites and the International Space Station. From 2007 to 2009, the International Space Station had an average of 10 minor impacts per month and had to perform several collision avoidance maneuvers to dodge debris that would have caused significant damage.

In addition to its destructive potential, orbital debris has a tendency to create additional debris as a result of collisions. Kessler Syndrome describes a state where the density of debris in a particular orbit has reached a threshold so that the rate of debris generation through debris-debris collisions surpasses the rate of orbital decay of debris in that same orbit. Once this state is reached, existing debris will cause a cascading effect whereby new debris is continually created and the total number of pieces of debris in that orbit increases. The dynamics of the newly created debris are difficult to predict, due to its completely random nature. Similarly, the trajectories of the new debris will be effectively random. The major implication of this phenomenon is that it renders space travel through this region unfeasible for many years, until the orbit of enough of this debris has decayed sufficiently to clear the area. Interestingly, orbit debris can be found in even non-traditional orbits due to the random nature of collisions between existing orbital debris.

The danger of orbital debris lies in its extremely high kinetic energy. Debris in orbit, regardless of its size, moves at orbital velocity. For low-earth orbit (LEO), this velocity is roughly 7 km/s. Due to the somewhat random nature of orbital debris creation, the debris in LEO tend to move in random directions. Thus, when a collision occurs, the relative velocities of the debris can vary widely to up to twice the orbital velocity. On average, the collision velocity in LEO is estimated to be roughly 10 km/s. For comparison, the speed of a bullet fired at sea level is roughly 1 km/s. Impacting orbital debris can potentially destroy an entire satellite with a single collision because of the extremely high velocities that are involved. In LEO, there is some air drag and a significant amount of plasma.

The International Space Station (ISS) was equipped with a plasma contactor for the purpose of protecting components of the ISS from electrical phenomena caused by interaction of components of the ISS with the plasma in LEO. The plasma contactor used a xenon gas to emit electrons and generate a high density plasma field in the vicinity of the device. However, a skilled person would not position this device in the path of the ISS since this would result in an acceleration of the orbital decay of the ISS, thereby increasing energy required to maintain the ISS in orbit.

To address the growing orbital debris problem, many methods/systems for debris removal have been considered. However, these methods are hindered by innate design limitations. U.S. Pat. No. 5,153,407 suggests sending a device into space, which device comprises a radiation source for generating radiation and means to monitor the debris and aim the radiation at a piece of debris. The radiation focused on the debris will desirably vaporize the debris. The device is complex in design and consumes a large amount of energy. This method also requires very precise aim, which is not reasonable for the range over which it is supposed to operate and taking into account the relative velocities of the satellite and debris.

U.S. Pat. No. 4,936,528 discloses a method and apparatus for mitigating orbital debris by using a collision medium to promote hyper-velocity collisions with the debris, and to trap any debris remaining after the collision. The collision medium may be streams of liquid droplets that are directed at the debris via the interior of an intake cone. After collision with the collision medium, the hyper-velocity debris is substantially vaporized. The collision medium and any residual debris after the collision may be directed to a collector at the end of the intake cone. The drawback of this method is that the collision medium is expended and may limit the life of the device or require refilling the device.

U.S. Pat. No. 5,405,108 teaches a method of sending a device made of energetic material to an orbit highly populated with debris. The device is then remotely detonated, and the force created by the expanding detonation products is imparted to the orbital debris. As a result, some debris will be pushed into a reentry orbit, while other debris will escape earth's gravitational pull. The device is destroyed after one use. So the cost of repeated launching of the device into space may be very high.

U.S. Pat. No. 6,655,637 discloses a deorbiting spacecraft comprising a grabber for collecting orbital debris and a de-orbitor. The grabber includes inflatable fingers with loop eyes for bending the fingers to grab the debris using controlled motors and tension lines. The de-orbitor may be a dragsphere for de-orbiting LEO debris into the atmosphere, or a surface for collecting solar wind for pushing the debris into an outer orbit, or a thruster for transporting high earth orbit debris to an outer waste orbit. This approach requires remote control of the grabber by ground personnel, who rely on knowing the position of the debris. However, debris with a maximum dimension of less than 10 cm is difficult to detect by ground satellites. Due to this limitation, the grabber or any system that relies on information from a ground station will not have the capability to monitor the position of such small debris.

These prior art devices use complex technology, making them expensive to build and operate. For clearing the estimated several million pieces of orbital debris, they are not cost effective. Therefore, there is a need in the field to provide a device and method to mitigate orbital debris in a more cost-effective manner. The present invention has the advantages of a simple design, a long operating life, and a low energy requirement that can potentially be fulfilled via solar energy collection.

### SUMMARY OF THE INVENTION

The present invention involves using a device in space to concentrate local plasma to a surrounding region to form a higher density plasma field (hereinafter “plasma field”). The satellite device comprises an electrical energy source, at least one cathode and at least one anode. The electrical energy source supplies pulsed energy to the cathode to concentrate the plasma.

Another objective of present invention is to send such a device into a space where debris is to be mitigated. The device creates a denser plasma field which exerts drag on debris passing through the plasma field. The drag force results in faster orbital decay for the debris.

The present invention also encompasses a method for mitigating orbital debris including the steps of positioning a device for concentration of plasma at a location relative to orbital debris that will cause the orbital debris to pass through a concentrated plasma field generated by the device and activating the device to concentrate plasma in the path of the orbital debris.

### BRIEF DESCRIPTION OF THE DRAWINGS

FIG. 1 shows a plasma field 5 surrounding one embodiment of the satellite device 1 of the present invention decelerating orbital debris.

FIG. 2 shows an exemplary parallel electrode 3 and 4 configuration for concentrating plasma in accordance with the invention.

FIG. 3 shows the impact of a plasma field 5 on the orbit of debris.

FIG. 4 shows that the lifetime of orbital debris decreases as a function of plasma density of the plasma field 5.

FIG. 5 is a diagram illustrating the effect of the density of the plasma field 5 on the lifetime of debris in low earth orbit (˜350 km latitude).

FIG. 6 is a diagram showing multiple satellite devices 1 1 working in conjunction with one another to create larger plasma field 5.

FIG. 7(a) is a diagram of multiple satellite devices 1 in a sequence array formation.

FIG. 7(b) is a diagram of multiple satellite devices 1 in a sweep array formation.

### DETAILED DESCRIPTION OF THE PREFERRED EMBODIMENT(S)

For illustrative purposes, the principles of the present invention are described by referencing various exemplary embodiments. Although certain embodiments of the invention are specifically described herein, one of ordinary skill in the art will readily recognize that the same principles are equally applicable to, and can be employed in other systems and methods. Before explaining the disclosed embodiments of the present invention in detail, it is to be understood that the invention is not limited in its application to the details of any particular embodiment shown. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

The present invention is directed to mitigating orbital debris 2 by concentrating the plasma existing in the outer space in the path of the orbital debris 2 in order to decelerate the debris 2 and cause its orbit to decay. The invention involves sending a device to a desired location in space and using the device to concentrate the plasma in space at that location. Concentration of the plasma enhances frictional drag on orbital debris 2 coming into contact with the concentrated plasma thereby transforming at least some of the kinetic energy of the debris 2 to heat or frictional loss. As a result, the orbital debris 2 will decelerate causing its orbit to decay. The goal of the debris mitigation method of the present invention is to accelerate the decay of the orbit of orbital debris 2 to hasten re-entry of the orbital debris 2 into the earth's atmosphere where it will burn up and be destroyed.

The satellite device 1 of the invention includes a means for concentrating plasma. In one embodiment, the means for concentrating plasma includes at least one cathode 4 and at least one anode 3 that are each connected to an electrical energy source. Pulsed energy is supplied to the electrodes 3 and 4 by the electrical energy source. The pulsed energy causes an electrical field to form via transfer of electrons between the electrodes 3 and 4. The electrical field serves to concentrate existing plasma in space to a higher density by providing an attractive force for the plasma. The concentrated plasma forms a plasma field 5, i.e. a region containing a higher density of plasma than surrounding regions. The present device is particularly useful in low earth orbit where orbital debris 2 is closer to the atmosphere and there is more plasma that can be concentrated as compared to higher orbits.

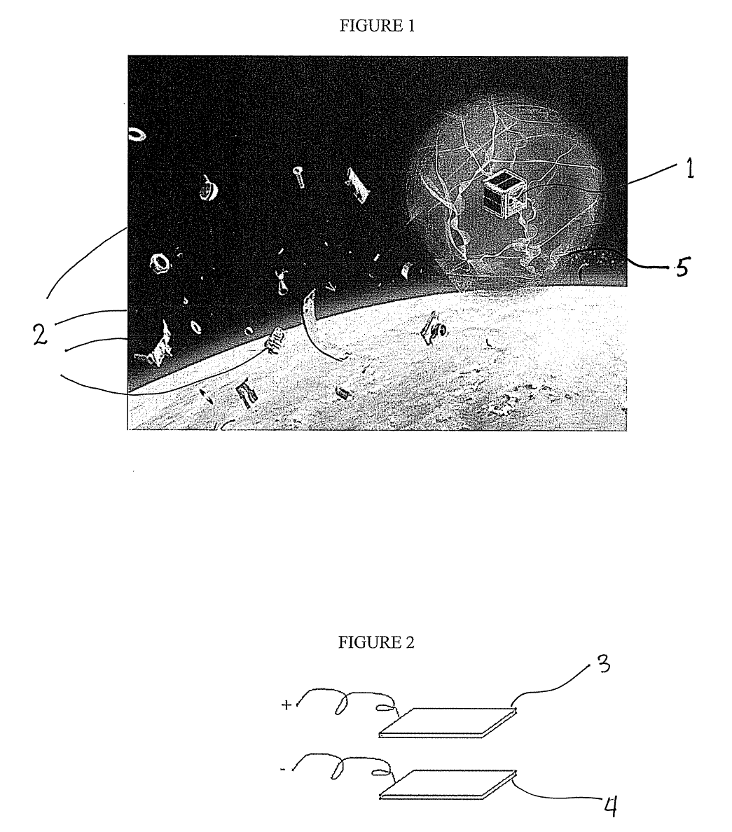

As depicted schematically in, FIG. 1, orbital debris 2 passing through the plasma field 5 will experience increased drag, as compared to surrounding space, which results in a frictional force on the debris 2 that decelerates the debris 2 and hastens orbital decay for the debris 2. Multiple satellites can be used in cooperation with one another to generate a larger plasma field 5 in order to influence orbital debris 2 over a larger area. This approach is more cost effective than many prior art approaches because it uses a device of simple design, which may be self-sustainable and will at least have a long operating life, due to its relatively low energy requirement.

The satellite device 1 of the present invention may have any shape. In one exemplary embodiment, the satellite device 1 may be conveniently made in a cubic shape. The satellite device 1 is preferably small in size, such as devices having a largest diameter of up to about 1 meter. The size and shape of the satellite device 1 are not critical to the present invention, as lone as the device 1 is capable of concentrate a plasma field 5 of sufficient size and density to accomplish the intended purpose.

The satellite device 1 includes a source of electrical energy for providing a pulsed energy to the electrodes 3 and 4. The energy source may include, for example, fuel cells, solar panels, batteries, radioisotope thermal generators, solar thermal generators, or any other method for generating power, and combination thereof. The energy may optionally be stored in batteries forming part of the device. The energy consumption of this satellite device 1 is expected to be significantly less than what is required for prior orbital debris mitigation devices.

The cathode 4 is connected to the electrical energy source and the anode 3 is grounded. There are no particular requirements for the shape and size of the electrodes 3 and 4, as long as the electrodes 3 and 4, when energized, function to concentrate local plasma. The electrodes 3 and 4 may be configured in any way that is suitable for concentrating plasma. Exemplary configurations include a parallel configuration wherein the electrode(s) 3 and 4 are in two separate parallel planes; a circular configuration wherein the cathode(s) 4 are placed in the center and the anode(s) 3 are placed in a circle surrounding the cathode(s) 4, or vice versa. FIG. 2 shows an exemplary embodiment of a suitable electrode configuration employing one anode plate electrode 3 and one cathode plate electrode 4 arranged in a parallel configuration. In another exemplary embodiment, the electrodes 3 and 4 may protrude from the surface of satellite device 1. In yet another exemplary embodiment, two electrodes 3 and 4 may be located on opposite surfaces of a satellite device 1.

Pulsed energy is transmitted from the electrical energy source to the cathode(s) 4 to attract and concentrate existing plasma in the surrounding region to form a higher density plasma field 5. The plasma in the plasma field 5 may be up to 100 times denser than the background plasma density existing at the location where the satellite device 1 is positioned.

The pulsed energy supplied to the cathode(s) 4 may have variety of different characteristics, such as various waveforms, durations, or lengths of gaps between pulses. Preferably, the pulsed energy is provided as a square wave. Another important characteristic of the pulsing is its frequency, which is related to the size of the plasma field 5 it creates. As a general rule, the higher the frequency, the larger the plasma field 5 is. The frequency of pulsing may be determined in consideration of the size and shape of satellite device 1, the size and shape and configuration of electrodes 3 and 4. Once the design of satellite device 1 and electrodes 3 and 4 is fixed, the optimal pulsing frequency may be determined by simple tests.

The plasma field 5 surrounding the satellite device 1 can create a drag force for the orbit debris 2 that flies through it. The drag force F_{D} may be estimated as:

$${F}_{D} = \frac{1}{2} ρ {C}_{D} AV \vert V \vert \qquad Equation 1$$

where:
F_{D} drag force created by the plasma field 5
C_{D} drag coefficient of the shape of debris 2
V relative velocity between the debris 2 and the plasma field 5
A area of debris 2 in orbit
ρ plasma density in the plasma field 5

From equation 1 it is clear that the drag force encountered by the debris 2 directly depends on the plasma density. The higher the density of the plasma field 5, the stronger the drag force is. It may be desirable to design satellite devices 1 that may generate a plasma field 5 with a high density. However, there may be a tradeoff with energy consumption. The present invention encompasses satellite devices 1 that may create a plasma field 5 with a density higher than the background plasma density in the surrounding area, preferably up to 100 times higher than the background plasma density.

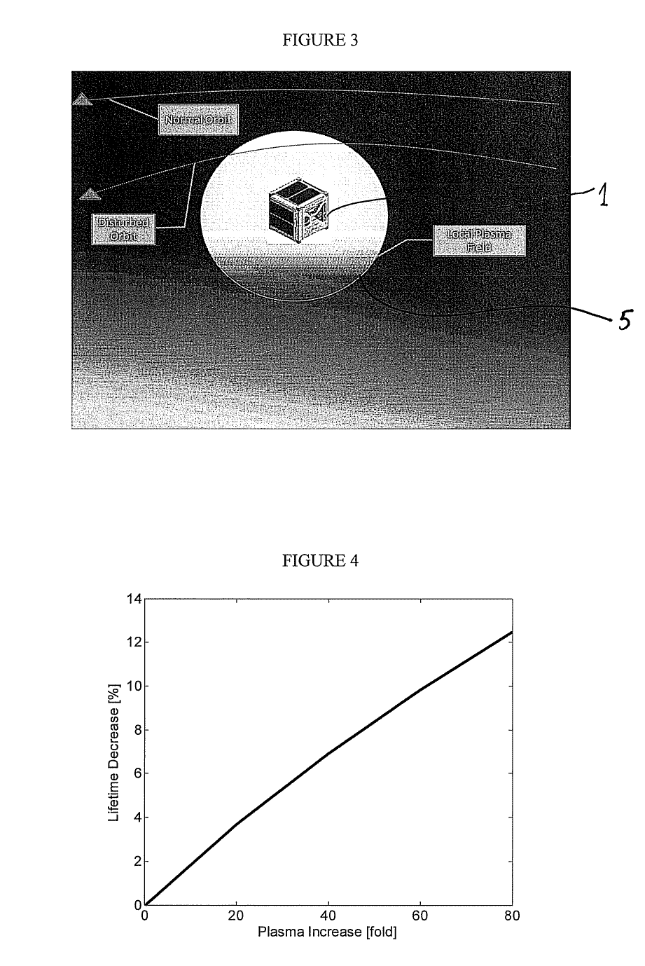

The direct impact of the drag force on the orbital debris 2 is a reduction of the velocity of the debris 2. The velocity of the orbital debris 2 is closely tied to the altitude of the debris 2. After the drag force of the plasma reduces the velocity of the orbital debris 2, the orbit of the orbital debris 2 will decay causing the debris 2 to lose altitude and thereby reduce the time until re-entry of the debris 2 into the atmosphere. FIGS. 3 and 4 illustrate this feature of the invention.

Generally speaking, the velocity of the orbital debris 2 may be represented by its energy, which has two components: kinetic energy and potential energy. The kinetic energy always acts in the direction of the debris motion, while potential energy acts in a direction perpendicular to that of the kinetic energy. The kinetic energy of the orbital debris 2 may be estimated as follows:

$$E = \frac{1}{2} m \cdot {v}^{2} - μ \cdot \frac{m}{R} \qquad Equation 2$$

where:
E kinetic energy of the orbit debris 2
m mass of the orbit debris 2
v velocity of the orbit debris 2
μ geocentric gravitational constant (˜398,600 km³s⁻²)
R radius of the debris' orbit from the center of the Earth (in km)

Equation 2 may be normalized with respect to the orbital debris' mass. Dividing the equation by mass, the normalized kinetic energy is:

$$ɛ = \frac{1}{2} {v}^{2} - \frac{μ}{R} \qquad Equation 3$$

where:
ε specific kinetic energy
v velocity of the orbit debris 2
μ geocentric gravitational constant (˜398,600 km³s⁻²)
R radius of the debris' orbit from the center of the Earth (in km)

Equation 1 may be used to calculate the orbital lifetime of debris 2 by taking an energy approach. By considering the specific kinetic energy of orbital debris 2, the impact of the drag of the plasma field 5 can be directly subtracted. More specifically, when drag forces are applied, such forces can be treated as if they act in the direction opposite of motion, which thereby reduces the kinetic energy of the debris 2. The kinetic energy of the orbital debris 2 is directly linked to the altitude of its orbit. This constant opposing drag force causes the debris 2 to lose kinetic energy and therefore lose altitude over the course of time, as shown in FIG. 3.

Using both Equation 1 and Equation 3, the energy change for the orbital debris 2 after passing through the plasma field 5 may be calculated by subtracting the impact of the plasma field 5 from the object's specific kinetic energy. More specifically, incorporating the drag force of Equation 1 into the energy equation (Equation 3), the change in energy of debris 2 in orbit after passing through the plasma field 5 is estimated as:

$${ɛ}_{i} = - \frac{μ}{2 {R}_{i - 1}} - \frac{{F}_{D} \cdot Δ x}{m} \qquad Equation 4$$

where:
F_{D} average drag force as calculated from Equation 1
Δx distance over which drag force is applied on the debris 2
m mass of the orbit debris 2
μ product of Earth's gravitational constant and its mass
R radius of the debris' orbit from the center of the Earth (in km)
i iteration index

As shown in Equation 4, the energy decrease after passing through the plasma field 5 depends on the size of the plasma field 5 (Δx), in addition to the plasma density (represented by F_{D}). The voltage between the electrodes 3 and 4 impacts the plasma density. The voltage is preferably over a thousand volts. As a general rule, higher voltage is preferred since higher plasma density may be produced. The size of the plasma field 5 is determined mainly by the frequency of the pulsed energy supplied by the electrical energy source to the electrodes 3 and 4.

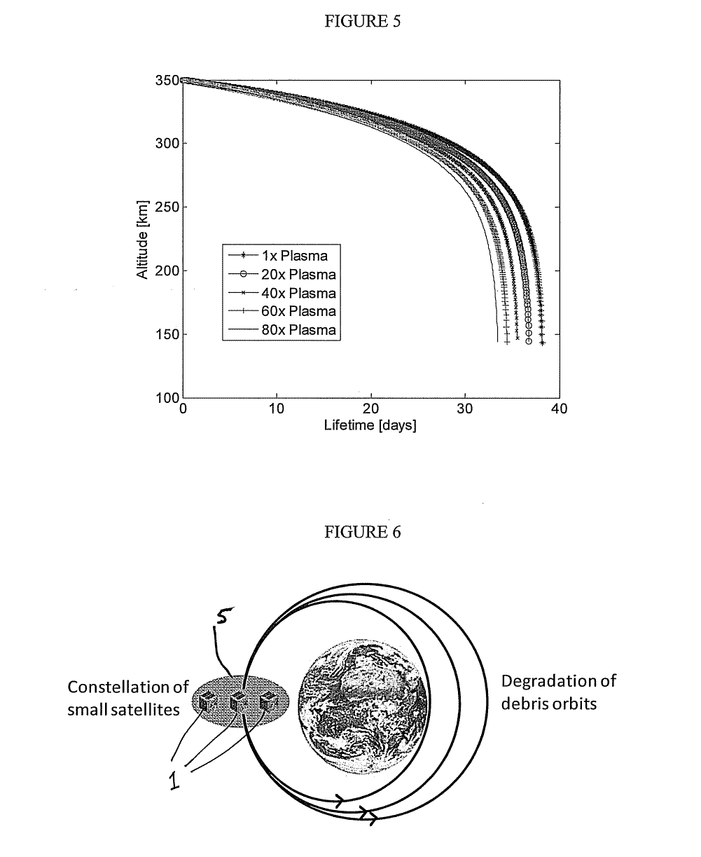

After one or more passes through the plasma field 5, the orbital debris 2 will lose a sufficient portion of its kinetic energy to be caused to enter the earth's atmosphere where the debris 2 is expected to be burned. There is a positive correlation between lifetime reduction of orbital debris 2 and the density of plasma field 5 that it encounters, as depicted in FIG. 5. The higher the density of the plasma field 5, the larger the lifetime reduction for the orbital debris 2. The lifetime reduction of the orbital debris 2 may be as much as about 12% assuming a density of the plasma field 5 is about 80 times the background plasma density.

Of the millions of pieces of orbital debris 2, debris 2 in certain orbits poses a larger risk than other debris 2. In one embodiment, the present invention includes a step of selecting the location or orbit in which the plasma field 5 will be created. Once the orbit or location is identified, the characteristics of particular debris 2 in the orbit and how soon the mission needs to be accomplished may be considered in relation to the type and/or number of satellites to be employed, the amount of energy to be used, the pulsing method, the frequency of the pulsing, as well as the number of passes the debris 2 will make through the plasma field 5.

Once a particular orbit or location is selected, one or more satellite devices 1 are deployed in that orbit or location. The satellite device 1 may be launched into the selected orbit via a carrier, such as a space shuttle or a carrier satellite. The satellite device 1 may be released after the carrier reaches the selected orbit. The satellite device 1 may optionally be assembled while still in a manned carrier or be pre-assembled prior to launch. Alternatively, the satellite device 1 may be launched into the orbit by its own rockets. A plurality of satellites can also be deployed in an array by a single carrier.

After the satellite device 1 is positioned in the desired orbit or location, it may be activated to begin concentration of the plasma. The activation may be remotely done by ground personnel, by a person in a manned carrier in space or by a control system deployed on the satellite itself or a remote control system designed for controlling one or more satellites. Such control systems may be implemented using computers that can be used to calculate optimal parameters for a particular mission, including energy requirements, satellite location, pulsing method and frequency, number of satellites required and the pattern in which a plurality of satellites are to be deployed.

The satellite device 1, once activate, will create a high density plasma field 5, preferably in the path of orbital debris 2. The present invention also encompasses the possibility of adjusting the operating parameters of the satellite device 1 after it has been activated, for example, to adjust to changing conditions. For example, the energy supplied, and/or the waveform and/or frequency of pulsing may be adjusted, as well as the relative positioning of plural satellites. The orbit of one or more satellite devices 1 may also be adjusted.

As shown in Equation 4, the kinetic energy decrease experienced by the orbital debris 2 after passing through the plasma field 5 depends on the size of the plasma field 5 (Δx). The longer the distance that the debris 2 is in the plasma field 5, the more kinetic energy loss the debris 2 will experience, and the more the debris 2 will be slowed down. In another aspect, the present invention employs multiple satellite devices 1 in cooperation to create a larger plasma field 5 and/or to create a series of plasma fields 5 through which the same orbital debris 2 will pass. FIG. 6 illustrates one aspect of this concept.

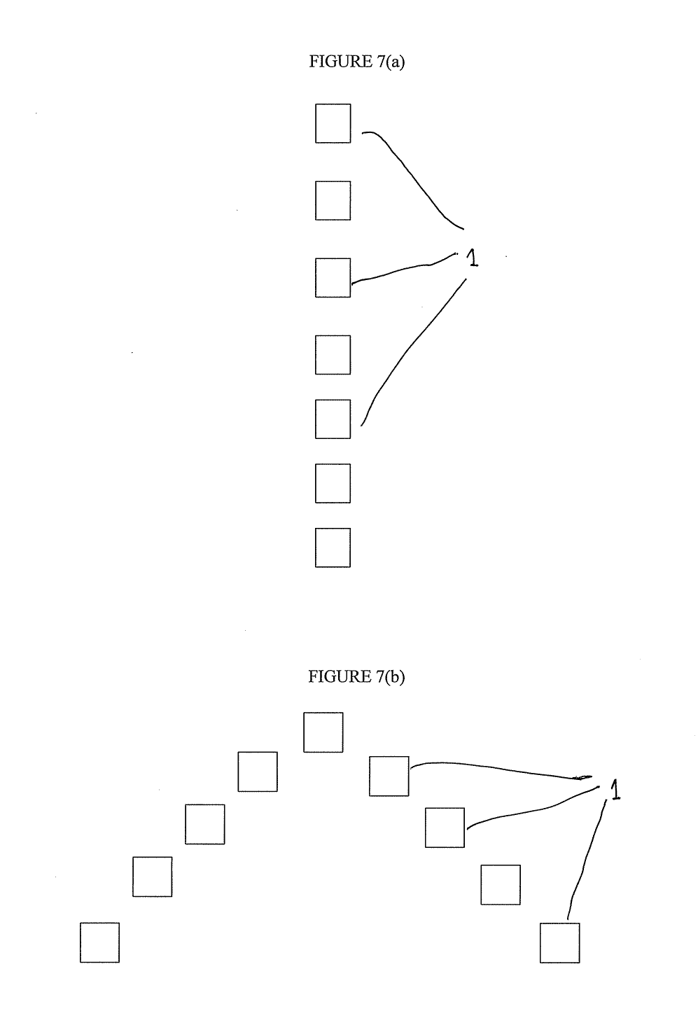

In one embodiment, multiple satellite devices 1 may be deployed in a sequential array formation, as shown in FIG. 7(a). Such a formation effectively creates a relatively long plasma field 5 causing a particular set of orbital debris 2 to remain for a longer time in the plasma field 5, thereby effectively experiencing a much larger distance Δx where the drag force is applied to the debris 2. In this manner, the debris 2 will lose even more energy, resulting in a faster orbital decay and more drastic lifetime reduction for such debris 2.

The present invention also contemplates the use of multiple satellite devices 1 in a sweep array, as shown in FIG. 7(b). The multiple satellite devices 1 in such a formation create a plasma field 5 with a large span to affect a wider swath of orbital debris 2. The sweep array formation may be used to clear a larger effective orbital area than a single satellite. Repeated passes of the sweep array through the same orbit may be used to subject the same debris 2 to multiple passes through the plasma field 5 thereby further accelerating the orbital decay of such debris 2.

In yet another embodiment of the present invention, this satellite device 1 can be used as part of a larger satellite that may have other functions, such as a GPS satellite or communication satellite. At the end of the life of the larger satellite, the satellite device 1 of present invention may be used to help bring down the larger satellite by creating a plasma field 5 in the path of the satellite. This may offer advantages in comparison to parachutes or balloons that are used in for this purpose.

The device and method of the present invention offers simplicity of design, is relatively inexpensive to build and operate as compared to some prior art devices, may be designed to have a low energy requirement, may be self sustainable, and thus may have a relatively long operating life.

### Example 1

Referring to FIG. 5, the relationship between the orbital lifetime reduction and the plasma density was simulated for one embodiment of the present invention, a cubic satellite device 1 with a 1-square meter cross-sectional area at a starting altitude of 350 km. The simulation is done using the satellite device 1 with varying plasma densities. The orbital decay is substantial since this orbital debris 2 has a normal orbital lifetime of 3 years. The simulation shows that a single pass through the plasma field 5 may reduce the lifetime of the orbital debris 2 by approximately 130 days. Multiple passes through the plasma field 5 could be used to further reduce the lifetime of the orbital debris 2.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meanings of the terms in which the appended claims are expressed.

What is claimed is:

1. A method of mitigating orbital debris comprising steps of:
positioning a device for concentration of plasma at a location relative to the orbital debris that will cause the orbital debris to pass through a concentrated plasma field generated by the device; and
activating the device to concentrate plasma in a path of the orbital debris.

2. The method of claim 1, wherein the device includes an electron emitter and said activation step activates the electron emitter to emit electrons from said device.

3. The method of claim 2, wherein the electron emitter comprises a cathode, an anode and an energy source for supplying electrical energy to the cathode.

4. The method of claim 3, wherein the cathode and anode are plate electrodes.

5. The method of claim 4, wherein the cathode and anode are arranged in a parallel arrangement.

6. The method of claim 1, wherein plurality of devices are positioned in an array and one or more of said devices are activated to concentrate plasma.

7. The method of claim 6, wherein said plurality of devices are deployed in a sweep array.

8. The method of claim 6, wherein said plurality of devices are deployed in a sequence array.

9. The method of claim 1, wherein the device is attached to the orbital debris and said step of positioning the device comprises a step of positioning the orbital debris to locate the device in the path of the orbital debris to which it is attached.

10. The method of claim 1, wherein the device does not employ a working fluid for plasma concentration.

11. The method of claim 1, wherein activation of the device concentrates plasma to a concentration of more than a concentration of background plasma up to about 100 times the concentration of the background plasma.

12. The method of claim 1, wherein said step of activating the device comprises the step of supplying pulsed energy to a cathode of the device.

13. The method of claim 12, wherein the pulsed energy is supplied in a form of a square wave.

14. The method of claim 3, wherein the voltage between said cathode and anode is over about one thousand volts.

15. A device for mitigating orbital debris comprising:
a cathode,
an anode, and
an electrical energy source which supplies pulsed energy to the cathode.

16. The device of claim 15, wherein said electrical energy source comprises a fuel cell.

17. The device of claim 15, wherein said electrical energy source comprises solar panels for collecting energy and an energy storage means.

18. The device of claim 15, wherein said pulsed energy has a square waveform.

19. The device of claim 15, wherein the voltage between said cathode and anode is over about one thousand volts.

20. The device of claim 15, further comprising a means for adjusting one or more of the amount of pulsed energy, the waveform of the pulsed energy and the frequency of the pulsed energy.
